(19) United States
(12) Patent Application Publication
(10) Pub. No.: US 2026/0125219 A1
(43) Pub. Date: May 7, 2026

(54) ADJUSTABLE CONVEYOR APPARATUS AND METHOD OF ASSEMBLY THEREOF

(71) Applicant: Galick Packaging Equipment Ltd., Wellesley (CA)

(72) Inventor: Sean Galick, St. Jacobs (CA)

(21) Appl. No.: 19/373,265

(22) Filed: Oct. 29, 2025

Related U.S. Application Data
(60) Provisional application No. 63/715,931, filed on Nov. 4, 2024.

(51) Int. Cl. B65G 21/20

(52) U.S. Cl. CPC B65G 21/2072; B65G 2201/0244

(57) ABSTRACT

An adjustable conveyor apparatus and method of assembly are provided. The apparatus includes a plurality of inner and outer adjustable rails respectively disposed on inner and outer sides of a conveyor device, a plurality of inner platforms and a plurality of outer platforms, each platform connected to a respective one of the inner adjustable rails or the outer adjustable rails, the platform having one or more handles for adjusting the respective adjustable rail, the platform having one or more brackets for attaching the respective adjustable rail to the conveyor device, the plurality of inner adjustable rails and the plurality of outer adjustable rails configured to be adjusted by operation of the respective one or more handles to provide an available width for the conveyor device to receive a payload and for the plurality of inner adjustable rails and the plurality of outer adjustable rails to guide the payload.

### TECHNICAL FIELD

The following relates generally to an adjustable apparatus, and more particularly to an adjustable conveyor apparatus and method of assembly thereof.

### INTRODUCTION

Conventional conveyor belts are ordinarily configured with respect to specific objects, or specific sizes of objects, and cannot be readily adapted to handle different objects or sizes thereof. For example, conventional conveyor belts have fixed rails that do not permit objects greater than a fixed maximum size and do not provide guidance or support to objects smaller than a fixed minimum size. Such conventional conveyor belts may not be able to adapt to new logistical challenges and may become less useful over time as unable to accommodate new objects.

Conventional adjustable railing conveyor systems are often complicated and highly expensive, including many moving pieces whose installation may be extremely complicated. Even where such difficulties are accepted or overcome, the ability of such supposedly adjustable conveyor systems may be limited, as such systems are often adjustable only be uninstalling and reinstalling all or some parts thereof. Even where such adjustment is ultimately possible, the adjustment may be imprecise and may cause inefficiencies, such as shingling on the conveyor system.

Accordingly, there is a need for an improved adjustable conveyor apparatus, and method of assembly thereof, that overcomes at least some of the disadvantages of existing apparatus and methods.

### SUMMARY

An adjustable conveyor apparatus is provided. The adjustable conveyor apparatus includes a plurality of inner adjustable rails disposed on an inner side of a conveyor device, a plurality of outer adjustable rails disposed on an outer side of the conveyor device, a plurality of inner platforms and a plurality of outer platforms, each platform connected to a respective one of the inner adjustable rails or the outer adjustable rails, the platform having one or more handles for adjusting the respective adjustable rail, the platform having one or more brackets for attaching the respective adjustable rail to the conveyor device, the plurality of inner adjustable rails and the plurality of outer adjustable rails configured to be adjusted by operation of the respective one or more handles to provide an available width for the conveyor device to receive a payload and for the plurality of inner adjustable rails and the plurality of outer adjustable rails to guide the payload.

The plurality of inner adjustable rails and the plurality of outer adjustable rails may be disposed about a curvature of the conveyor device.

The curvature may be 90 degrees.

The curvature may be 180 degrees.

The curvature may be 45 degrees.

The curvature may be 135 degrees.

The one or more brackets may include respective vertical slots for receiving one or more fasteners for attaching the one or more brackets to the conveyor device.

The one or more brackets may include respective horizontal slots for receiving the respective one or more handles.

A method of assembling an adjustable conveyor apparatus is provided. The method includes connecting a first inner adjustable rail to a first platform, a second inner adjustable rail to a second platform, a first outer adjustable rail to a third platform, and a second outer adjustable rail to a fourth platform, disposing the first and second inner adjustable rails on an inner side of a conveyor device, disposing the first and second outer adjustable rails on an outer side of the conveyor device, attaching the disposed adjustable rails to respective sides of the conveyor device using respective brackets, the plurality of inner adjustable rails and the plurality of outer adjustable rails configured to be adjusted by operation of respective handles thereat, to provide an available width for the conveyor device to receive a payload and for the plurality of inner adjustable rails and the plurality of outer adjustable rails to guide the payload.

The plurality of inner adjustable rails and the plurality of outer adjustable rails may be disposed about a curvature of the conveyor device.

The curvature may be 90 degrees.

The curvature may be 180 degrees.

The curvature may be 45 degrees.

The curvature may be 135 degrees.

Each platform may have one or more brackets for attaching the respective adjustable rail to the conveyor device, the one or more brackets including respective vertical slots for receiving one or more fasteners for attaching the one or more brackets to the conveyor device.

Each platform may have one or more brackets for attaching the respective adjustable rail to the conveyor device, the one or more brackets including respective horizontal slots for receiving the respective handles.

An adjustable conveyor apparatus for performing a side transfer from a first conveyor device to a second conveyor device is provided. The adjustable conveyor apparatus includes one or more inner adjustable rails and one or more outer adjustable rails disposed between the first and second conveyor devices and a plurality of platforms, each platform connected to a respective one of the inner adjustable rails or the outer adjustable rails, the platform having one or more handles for adjusting the respective adjustable rail, the platform having one or more brackets for attaching the respective adjustable rail between the two conveyor devices, the plurality of inner adjustable rails and the plurality of outer adjustable rails configured to be adjusted by operation of the respective one or more handles to provide an available width for receiving a payload and for the one or more inner adjustable rails and the one or more outer adjustable rails to guide the payload from the first conveyor device to the second conveyor device.

The one or more brackets may include respective vertical slots for receiving one or more fasteners for attaching the one or more brackets to the first conveyor device or the second conveyor device.

The one or more brackets may include respective horizontal slots for receiving the respective one or more handles.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a perspective view of an adjustable conveyor apparatus, according to an embodiment;

FIG. 1B is a side view of the adjustable conveyor apparatus of FIG. 1A;

FIG. 2 is an angled side view of the adjustable conveyor apparatus of FIG. 1A;

FIG. 3 is a flow diagram of a method of assembling the adjustable conveyor apparatus of FIG. 1A, according to an embodiment;

FIG. 4 is an elevated perspective view of an adjustable conveyor apparatus for performing a side transfer, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistants, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to an adjustable apparatus, and more particularly to an adjustable conveyor apparatus and methods of assembly and use therefor.

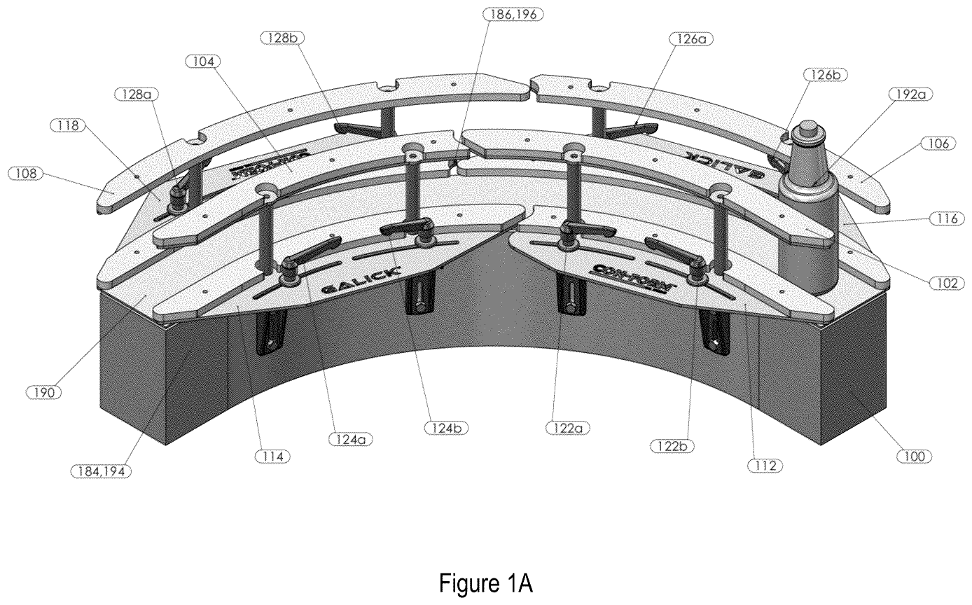

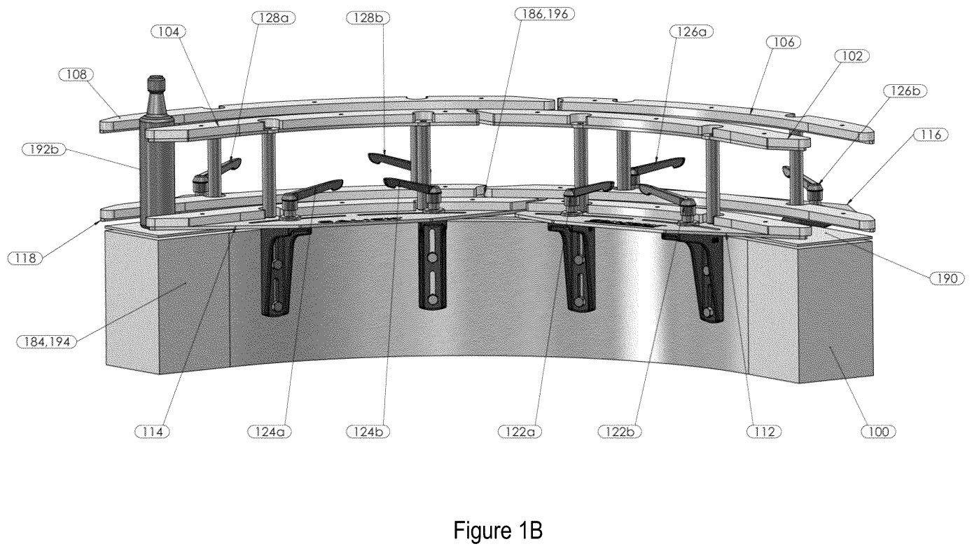

Referring now to FIGS. 1A-1B, shown therein are elevated perspective views of an adjustable conveyor apparatus 100, according to an embodiment. Although the adjustable conveyor apparatus 100 is configured differently in FIGS. 1A and 1B, to accommodate different payloads 192a, 192b, it will be appreciated that the different views show the same embodiment of the adjustable conveyor apparatus 100.

In the interest of clarity, a complete set of labels of the components of the embodiment shown in FIGS. 1A-1B has been provided across FIGS. 1A-1B, and the same components are not labelled twice therein.

The adjustable conveyor apparatus 100 is configured to be attached to, mounted on, or otherwise disposed atop or at a conveyor device 190. The conveyor device 190 is configured to convey, transport, or otherwise receive and move the payloads 192a, 192b. The conveyor device 190 may be a conveyor belt. The conveyor belt may be or may include a corner or transfer point between two or more conveyors (e.g., two or more conveyor belts). Such conveyors may use table-top chain or modular belts.

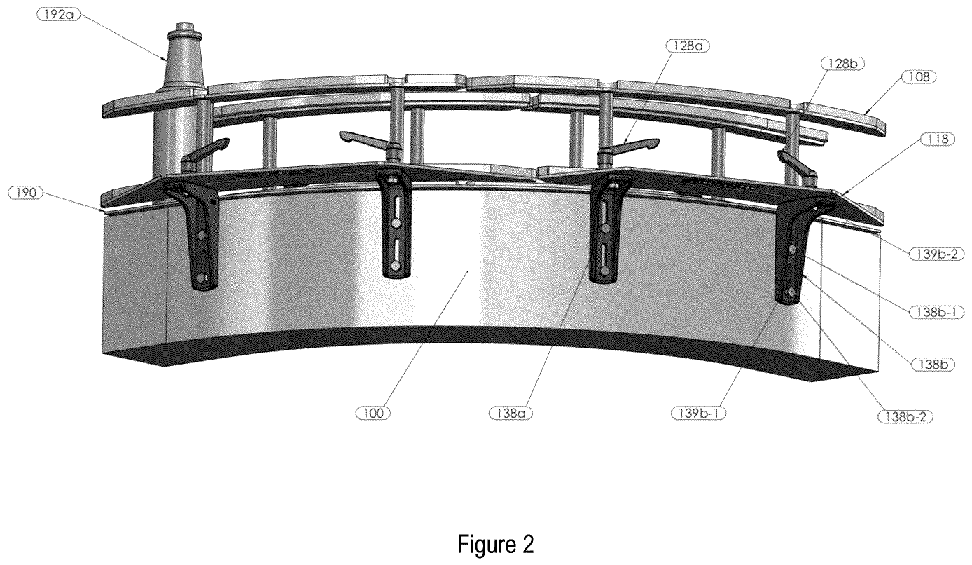

The apparatus 100 includes adjustable rails 102, 104, 106, 108 (collectively the adjustable rails and generically the adjustable rail). In the embodiment shown in FIGS. 1A-2, the adjustable rails are organized in pairs, with the adjustable rails 102, 106 guiding the payload 192a or 192b in a first part of the conveyor device 190 and the adjustable rails 104, 108 guiding the payload 192a or 192b in a second part of the conveyor device 190. However, it will be appreciated that the adjustable rails may be organized in a manner other than pairs (e.g., three adjustable rails on one side of the conveyor device 190, and two adjustable rails on the other side).

The adjustable rails 102, 104 are disposed on a first side 194 of the conveyor device 190 and together form an inner side 184 of the apparatus 100 (according to the curvature of the conveyor device 190). The adjustable rails 106, 108 are disposed on a second side 196 of the conveyor device 190 and together form an outer side 186 of the apparatus 100 (according to the curvature of the conveyor device 190).

It will be appreciated that, due to the curved nature of the conveyor device 190, the first side 194 and the inner side 184 have a lesser length than the second side 196 and the outer side 186, respectively. In a preferred embodiment, a 90-degree curvature is shown at the conveyor device 190 as further accommodated by the apparatus 100. It will be appreciated that any angle of the conveyor device 190 may be accommodated by the apparatus 100 (e.g., 180 degrees, 45 degrees). For example, a 180-degree turn in the conveyor device 190 may be accommodated at the apparatus 100 by providing further adjustable rails (e.g., two more first additional adjustable rails at the inner side 184 and two more second additional adjustable rails at the outer side 186 and respectively facing the two more first additional adjustable rails). For example, smaller or arbitrary angles in the conveyor device 190 may be accommodated at the apparatus 100 by providing smaller adjustable rails. For example, larger or arbitrary angles in the conveyor device 190 may be accommodated at the apparatus 100 by providing larger adjustable rails.

The conveyor device 190 underlying the apparatus 100 may be anywhere from 3 inches wide to 12 inches wide. A preferred embodiment of the apparatus 100 is suitable for a conveyor device 190 that is approximately 4.5 inches wide.

The apparatus 100 further includes platforms 112, 114, 116, 118 respectively connected to and adjacent the adjustable rails 102, 104, 106, 108. The platforms 112, 114, 116, 118 each respectively include female handles 122a, 122b; 124a, 124b; 126a, 126b; 128a, 128b for adjusting the respective adjustable rails 102, 104, 106, 108. For ease of reference, like numerals denote corresponding components as among the adjustable rails, the platforms, and the handles.

Each pair of handles (e.g., the handles 122a, 122b) is configured to move the respective adjustable rail (e.g., the adjustable rail 102) towards or away from an opposing adjustable rail (e.g., the adjustable rail 106), i.e., at least substantially perpendicularly relative to a direction of movement of the payload 192a, 192b along the conveyor device 190. Such movement of the respective adjustable rail (with or without corresponding movement of such opposing adjustable rail) has the effect of enlarging or shrinking the available width for the payload 192a, 192b to pass along the conveyor device 190. An optimal width for the payload 192a, 192b enables the conveyor device 190 to move the payload 192a, 192b along a turn (e.g., the 90-degree turn shown in FIGS. 1A-1B) without the payload 192a, 192b falling or becoming damaged.

If the available width is too large for the payload 192a, 192b, the payload 192a, 192b may fall or become damaged. If the available width is too small for the payload 192a, 192b, the payload 192a, 192b may not be able to proceed along the conveyor device 190.

It may be seen that the payload 192a in FIG. 1A is larger than the payload 192b in FIG. 1B. Accordingly, the available width of the apparatus 100 in FIG. 1A is greater than the available width of the apparatus 100 in FIG. 1B. The apparatus as shown in FIG. 1A may be adjusted via the handles and the adjustable rails as hereinabove discussed in order to enlarge or shrink the available width.

The handles (e.g., the handles 122a, 122b) may be designed to be operated manually, i.e., by a human operator. The handles may be designed to be operated automatically (e.g., by a machine such as a robot). The handles may be designed such that turning a single handle suffices to adjust the corresponding adjustable rail. The handles may be designed such that turning both handles adjusts the corresponding adjustable rail.

The handles permit fine adjustments by hand in order to provide an optimal available width for the payload.

In an embodiment, the handles corresponding to a platform (e.g., the handles 122a, 122b corresponding to the platform 112) are turned counter-clockwise to loosen the handles and vary the space between an adjustable rail on one side of the apparatus 100 and another adjustable rail on the opposite side of the apparatus (e.g., between the adjustable rail 102 on the inner side 184 and the adjustable rail 106 on the outer side 194). In the embodiment, the handles are turned clockwise to tighten the handles and lock the adjustable rail into place.

Referring now to FIG. 2, shown therein is a side view of the adjustable conveyor apparatus 100.

At each platform, brackets are provided for reversibly or removably attaching the respective platform and rail to the conveyor device 190. For example and as shown in FIG. 2, the platform 118 includes brackets 138a and 138b attached to the conveyor device 190. Each bracket 138a, 138b corresponds to the respective handle 128a, 128b.

The bracket 138b further includes fasteners 138b-1, 138b-2 for attaching the platform 118 to the conveyor device 190. It will be appreciated that each bracket includes respective fasteners received at a slot, of which only a vertical slot 139b-1 and fasteners 138b-1, 138-b are labelled for clarity. The slot 139b-1 may extend along substantially the entire length of the bracket 138b in order to accommodate different sizes of adjustable rails and conveyor devices 190. The fasteners 138b-1, 138b-2 are hex bolts. It will be appreciated that the fasteners 138b-1, 138b-2 may include or may be bolts, screws, nails, rivets, tabs, or welded threaded studs. The fasteners 138b-1, 138b-2 are received through the slot 139b-1 at holes (not shown) in the conveyor device 190. It will be appreciated by one of skill in the art that the brackets 138 may be attached to the conveyor device 190 in other ways.

The bracket 138b further includes a horizontal slot 139b-2 for receiving the handle 128b.

It will be appreciated that discussion of the bracket 138b and components connected thereto is applied, mutatis mutandis, to the other brackets and components of the apparatus 100.

Because the platform 118 including the handles 128a, 128b is attached to the conveyor device 190 via the bracket 138, movement of the adjustable rail 108 via actuating the handles 128a, 128b causes the adjustable rail 108 to move relative to the conveyor device 190 while the platform 118 remains stationary relative to the conveyor device 190.

The brackets may be metal.

In a first configuration as shown in FIG. 1A, the apparatus 100 may be able to accommodate a payload 192 as small as a bottle having a diameter of 1 inch. In a second configuration as shown in FIG. 1B, the apparatus 100 may be able to accommodate a payload 192 as large as a 2.5-gallon container. The apparatus 100 may advantageously be adjustable between the first configuration and the second configuration, in the same embodiment, on the same conveyor device 190, with as little as 20 seconds of adjustment.

Any or all of the foregoing components of the apparatus 100, including the adjustable rails 102, 104, 106, 108, may be made of one or more of metal (e.g., steel), plastic, wood, and/or composite.

In a preferred embodiment, the apparatus 100 is made of stainless steel.

In an embodiment, the apparatus 100 includes precisely four adjustable rails, i.e., the adjustable rails 102, 104, 106, 108.

In an embodiment, the apparatus 100 includes more than four adjustable rails, i.e., the adjustable rails 102, 104, 106, 108 and further adjustable rails (not shown).

The apparatus 100 may advantageously be quickly and easily disassembled, cleaned, and reassembled by hand.

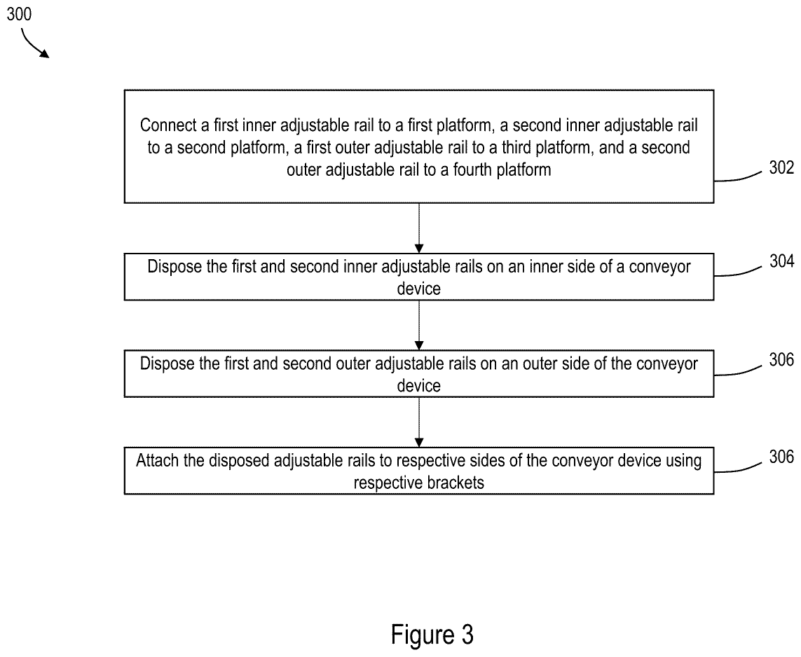

Referring now to FIG. 3, shown therein is a flow diagram of a method 300 of assembling an adjustable conveyor apparatus, according to an embodiment. The adjustable conveyor apparatus may be the adjustable conveyor apparatus 100 of FIGS. 1A-2.

At 302, the method 300 includes connecting a first inner adjustable rail to a first platform, a second inner adjustable rail to a second platform, a first outer adjustable rail to a third platform, and a second outer adjustable rail to a fourth platform.

At 304, the method 300 includes disposing the first and second inner adjustable rails on an inner side of a conveyor device.

At 306, the method 300 includes disposing the first and second outer adjustable rails on an outer side of the conveyor device.

At 308, the method 300 includes attaching the disposed adjustable rails to respective sides of the conveyor device using respective brackets.

The adjustable rails include handles such that the adjustable rails are adjustable relative to the conveyor device, for example to accommodate payloads of different sizes as shown in FIGS. 1A and 1B. For example, when accommodating a different payload, a user may use the handles to adjust the adjustable rails to a maximum available width (e.g., loosening the apparatus) and further adjust opposing inner and outer adjustable rails until the available width is appropriate for the different payload.

The method 300 may be applied to an existing conveyor device, already assembled, and may be considered a method of retrofitting the apparatus to an existing conveyor device.

The method 300 may be applied to a conveyor device not yet assembled, and may be considered a method of building the apparatus onto or in an existing conveyor device.

The brackets may be pre-formed.

The method 300 may include forming the brackets according to the dimensions or tolerances of the apparatus or the conveyor device.

It will be appreciated by one of skill in the art that the foregoing elements of the method 300 may be performed in a different order. It will be appreciated by one of skill in the art that the foregoing elements of the method 300 may be performed in any suitable order.

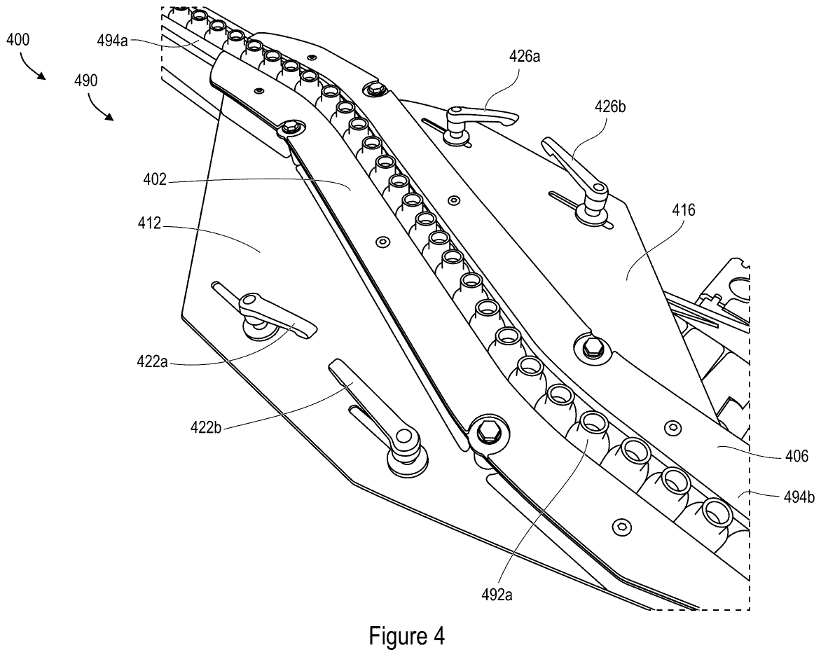

Referring now to FIG. 4, shown therein is an elevated perspective view of an adjustable conveyor apparatus 400 for performing a side transfer, according to an embodiment. Like numerals denote like references with respect to FIG. 1A.

In FIG. 4, the conveyor device 490 includes two components, a first conveyor device 494a and a second conveyor device 494b. The first and second conveyor devices 494a, 494b may be entirely different conveyor devices.

The adjustable conveyor apparatus 400 is configured to perform a side transfer by guiding the payload 492a (of which only one instance is labelled for clarity), via the adjustable rails 402, 406 from the first conveyor device 494a to the second conveyor device 494b.

While the above description provides examples of one or more apparatus, methods, or devices, it will be appreciated that other apparatus, methods, or devices may be within the scope of the claims as interpreted by one of skill in the art.

1. An adjustable conveyor apparatus comprising:
a plurality of inner adjustable rails disposed on an inner side of a conveyor device;
a plurality of outer adjustable rails disposed on an outer side of the conveyor device;
a plurality of inner platforms and a plurality of outer platforms, each platform connected to a respective one of the inner adjustable rails or the outer adjustable rails, the platform having one or more handles for adjusting the respective adjustable rail, the platform having one or more brackets for attaching the respective adjustable rail to the conveyor device;
wherein the plurality of inner adjustable rails and the plurality of outer adjustable rails are configured to be adjusted by operation of the respective one or more handles to provide an available width for the conveyor device to receive a payload and for the plurality of inner adjustable rails and the plurality of outer adjustable rails to guide the payload.

2. The adjustable conveyor apparatus of claim 1, wherein the plurality of inner adjustable rails and the plurality of outer adjustable rails are disposed about a curvature of the conveyor device.

3. The adjustable conveyor apparatus of claim 2, wherein the curvature is 90 degrees.

4. The adjustable conveyor apparatus of claim 2, wherein the curvature is 180 degrees.

5. The adjustable conveyor apparatus of claim 2, wherein the curvature is 45 degrees.

6. The adjustable conveyor apparatus of claim 2, wherein the curvature is 135 degrees.

7. The adjustable conveyor apparatus of claim 1, wherein the one or more brackets include respective vertical slots for receiving one or more fasteners for attaching the one or more brackets to the conveyor device.

8. The adjustable conveyor apparatus of claim 1, wherein the one or more brackets include respective horizontal slots for receiving the respective one or more handles.

9. A method of assembling an adjustable conveyor apparatus, the method comprising:
connecting a first inner adjustable rail to a first platform, a second inner adjustable rail to a second platform, a first outer adjustable rail to a third platform, and a second outer adjustable rail to a fourth platform;
disposing the first and second inner adjustable rails on an inner side of a conveyor device;
disposing the first and second outer adjustable rails on an outer side of the conveyor device;
attaching the disposed adjustable rails to respective sides of the conveyor device using respective brackets;
wherein the plurality of inner adjustable rails and the plurality of outer adjustable rails are configured to be adjusted by operation of respective handles thereat, to provide an available width for the conveyor device to receive a payload and for the plurality of inner adjustable rails and the plurality of outer adjustable rails to guide the payload.

10. The method of claim 9, wherein the plurality of inner adjustable rails and the plurality of outer adjustable rails are disposed about a curvature of the conveyor device.

11. The method of claim 10, wherein the curvature is 90 degrees.

12. The method of claim 10, wherein the curvature is 180 degrees.

13. The method of claim 10, wherein the curvature is 45 degrees.

14. The method of claim 10, wherein the curvature is 135 degrees.

15. The method of claim 9, each platform having one or more brackets for attaching the respective adjustable rail to the conveyor device, wherein the one or more brackets include respective vertical slots for receiving one or more fasteners for attaching the one or more brackets to the conveyor device.

16. The method of claim 9, each platform having one or more brackets for attaching the respective adjustable rail to the conveyor device, wherein the one or more brackets include respective horizontal slots for receiving the respective handles.

17. An adjustable conveyor apparatus for performing a side transfer from a first conveyor device to a second conveyor device, the adjustable conveyor apparatus comprising:
one or more inner adjustable rails and one or more outer adjustable rails disposed between the first and second conveyor devices; and
a plurality of platforms, each platform connected to a respective one of the inner adjustable rails or the outer adjustable rails, the platform having one or more handles for adjusting the respective adjustable rail, the platform having one or more brackets for attaching the respective adjustable rail between the two conveyor devices;
wherein the plurality of inner adjustable rails and the plurality of outer adjustable rails are configured to be adjusted by operation of the respective one or more handles to provide an available width for receiving a payload and for the one or more inner adjustable rails and the one or more outer adjustable rails to guide the payload from the first conveyor device to the second conveyor device.

18. The adjustable conveyor apparatus of claim 17, wherein the one or more brackets include respective vertical slots for receiving one or more fasteners for attaching the one or more brackets to the first conveyor device or the second conveyor device.

19. The adjustable conveyor apparatus of claim 17, wherein the one or more brackets include respective horizontal slots for receiving the respective one or more handles.
